(19) United States
(12) Patent Application Publication
(10) Pub. No.: US 2015/0290721 A1
(43) Pub. Date: Oct. 15, 2015

(54) APPARATUS AND METHOD FOR AN EXPANSION ARBOR

(71) Applicants: Martin A. Rightmire, Chattanooga, TN (US); Ken Driver, Chattanooga, TN (US)

(72) Inventors: Martin A. Rightmire, Chattanooga, TN (US); Ken Driver, Chattanooga, TN (US)

(21) Appl. No.: 14/683,609

(22) Filed: Apr. 10, 2015

Related U.S. Application Data
(60) Provisional application No. 61/995,442, filed on Apr. 10, 2014.

(51) Int. Cl. B23B 31/40; B24B 45/00

(52) U.S. Cl. CPC B23B 31/4013; B23B 31/4033; B24B 45/00

(57) ABSTRACT

An expansion arbor adapted for use on a rotational arbor core comprising an arbor first end having an arbor first end opening, an arbor second end having an arbor second end opening and being spaced apart from the arbor first end, a substantially cylindrical body that defines a longitudinal axis, and a slit having a slit first end and a slit second end and extending along a portion of the substantially cylindrical body between the arbor first end and the arbor second end. A portion of the substantially cylindrical body adjacent to the slit is adapted to expand radially outward when the rotational arbor core is rotated so as to retain a sanding sleeve on the rotational arbor core. A method comprising placing the expansion arbor on the rotational arbor core, placing the sanding sleeve on the expansion arbor, and rotating the rotational arbor core.

### CROSS-REFERENCES TO RELATED APPLICATIONS/PATENTS

This application relates back to and claims the benefit of priority from U.S. Provisional Application for Patent Ser. No. 61/995,442 entitled “Expansion Arbor” and dated Apr. 10, 2014.

### FIELD OF THE INVENTION

The present invention relates generally to devices and methods for grinding and sanding orthotic and prosthetic devices, and particularly to arbors used to grind and sand orthotic and prosthetic devices.

### BACKGROUND AND DESCRIPTION OF THE PRIOR ART

It is known to use a variety of devices such as arbors and methods to grind and sand orthotic and prosthetic devices. Conventional devices and methods, however, suffer from one or more disadvantages. For example, conventional arbors do not adequately retain a sanding sleeve on an arbor core. Conventional arbors also do not provide a sufficiently smooth grinding surface adapted to produce straight lines and a high quality finish. In addition, conventional arbors do not sufficiently eliminate grinding chatter, particularly on harder grinding surfaces. Further, conventional arbors are not sufficiently safe and do not optimize production efficiency.

It would be desirable, therefore, if an apparatus and method for an expansion arbor could be provided that would adequately retain a sanding sleeve on an arbor core. It would also be desirable if such an apparatus and method for an expansion arbor could be provided that would provide a sufficiently smooth grinding surface adapted to produce straight lines and a high quality finish. It would be further desirable if such an apparatus and method for an expansion arbor could be provided that would minimize or eliminate grinding chatter, particularly on harder grinding surfaces. It would be still further desirable if such an apparatus and method for an expansion arbor could be provided that would be safe to use and optimize production efficiency.

### Advantages of the Preferred Embodiments of the Invention

Accordingly, it is an advantage of the preferred embodiments of the invention claimed herein to provide an apparatus and method for an expansion arbor that adequately retains a sanding sleeve on an arbor core. It is also an advantage of the preferred embodiments of the invention claimed herein to provide an apparatus and method for an expansion arbor that has a sufficiently smooth grinding surface adapted to produce straight lines and a high quality finish. It is another advantage of the preferred embodiments of the invention claimed herein to provide an apparatus and method for an expansion arbor that minimizes or eliminates grinding chatter, particularly on harder grinding surfaces. It is an advantage of the preferred embodiments of the invention claimed herein to provide an apparatus and method for an expansion arbor that is safe to use and optimizes production efficiency.

Additional advantages of the preferred embodiments of the invention will become apparent from an examination of the drawings and the ensuing description.

### SUMMARY OF THE INVENTION

The apparatus of the invention comprises an expansion arbor adapted for use on a rotational arbor core. The preferred expansion arbor comprises an arbor first end having an arbor first end opening, an arbor second end having an arbor second end opening and being spaced apart from the arbor first end, a substantially cylindrical body that is disposed between the arbor first end and the arbor second end and defines a longitudinal axis, and a slit having a slit first end and a slit second end and extending along a portion of the substantially cylindrical body between the arbor first end and the arbor second end. In the preferred expansion arbor, a portion of the substantially cylindrical body adjacent to the slit is adapted to expand radially outward when the rotational arbor core is rotated so as to retain a sanding sleeve on the rotational arbor core.

The method of the invention comprises providing an expansion arbor adapted for use on a rotational arbor core as described in the immediately preceding paragraph. The preferred method further comprises placing the expansion arbor on the rotational arbor core, placing the sanding sleeve on the expansion arbor, and rotating the rotational arbor core.

### BRIEF DESCRIPTION OF THE DRAWINGS

The presently preferred embodiments of the invention are illustrated in the accompanying drawings, in which like reference numerals represent like parts throughout, and in which:

FIG. 1 is a perspective view of the preferred embodiment of the expansion arbor in accordance with present invention.

FIG. 2 is a perspective view of a first exemplary rotational arbor core adapted for use with the expansion arbor illustrated in FIG. 1.

FIG. 3 is a perspective view of a first alternative embodiment of the expansion arbor in accordance with the present invention.

FIG. 4 is a perspective view of a second exemplary rotational arbor core adapted for use with the expansion arbor illustrated in FIG. 3.

FIG. 5 is a perspective view of a second alternative embodiment of the expansion arbor in accordance with the present invention.

FIG. 6 is a perspective view of a third exemplary rotational arbor core adapted for use with the expansion arbor illustrated in FIG. 5.

FIG. 7 is a front view of a third alternative embodiment of the expansion arbor in accordance with the present invention and a fourth exemplary rotational arbor core in a stationary condition.

FIG. 7A is a right end view of the preferred embodiment of the expansion arbor illustrated in FIG. 7.

FIG. 8 is a front view of the preferred embodiment of the expansion arbor illustrated in FIGS. 7 and 7A shown in an expanded condition.

FIG. 8A is a right end view of the preferred expansion arbor illustrated in FIGS. 7-8 shown in an expanded condition.

FIG. 9 is a front view of an exemplary sanding sleeve adapted for use with the preferred expansion arbors of the present invention.

FIG. 9A is a right end view of the exemplary sanding sleeve illustrated in FIG. 9.

### DESCRIPTION OF THE PREFERRED EMBODIMENTS OF THE INVENTION

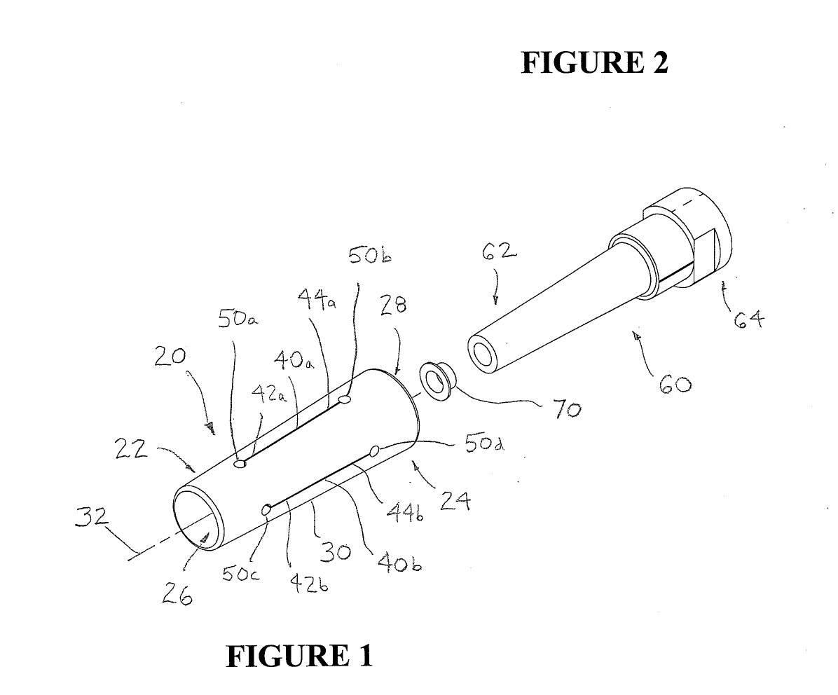

Referring now to the drawings, the preferred embodiments of the apparatus and method for an expansion arbor in accordance with the present invention are illustrated by FIGS. 1 through 9A. As shown in FIGS. 1-9A, the preferred embodiments of the invention described and claimed herein are adapted to provide an apparatus and method for an expansion arbor that adequately retains a sanding sleeve on an arbor core. The preferred embodiments of the invention described and claimed herein also provide an apparatus and method for an expansion arbor that has a sufficiently smooth grinding surface adapted to produce straight lines and a high quality finish. The preferred embodiments of the invention described and claimed herein further provide an apparatus and method for an expansion arbor that minimizes or eliminates grinding chatter, particularly on harder grinding surfaces. The preferred embodiments of the invention described and claimed herein still further provide an apparatus and method for an expansion arbor that is safe to use and optimizes production efficiency.

Referring now to FIG. 1, a perspective view of the preferred embodiment of the expansion arbor in accordance with present invention is illustrated. As shown in FIG. 1, the preferred expansion arbor is designated generally by reference numeral 20. Preferred expansion arbor 20 is adapted for use on a rotational arbor core (see, e.g., FIG. 2) and comprises silicone. Preferably, expansion arbor 20 comprises silicone having a hardness in the range of approximately 20 durometers to approximately 30 durometers and most preferably approximately 25 durometers. The preferred expansion arbor 20 is formed by a silicone that is mixed with a catalyst and poured into a mold. It is also contemplated within the scope of the invention that a relatively small amount of pigment may be added to the two-part silicone mixture in order to provide color. It is also contemplated within the scope of the invention that the silicone in the preferred expansion arbor may have a hardness of less than approximately 20 durometers or more than approximately 30 durometers. Further, it is contemplated within the scope of the invention that the silicone may comprise a mixture of two or more different types of silicones. Still further, it is contemplated within the scope of the invention that the silicone is not mixed with a catalyst. It is also contemplated within the scope of the invention that the expansion arbor comprises one or more elastomeric materials.

Still referring to FIG. 1, preferred expansion arbor 20 also comprises arbor first end 22 and arbor second end 24. Preferred arbor first end has arbor first end opening 26, and preferred arbor second end has arbor second end opening 28. Preferred arbor second end 24 is spaced apart from preferred arbor first end 22. Preferred arbor first end opening 26 is smaller than preferred arbor second end opening 28. Preferred expansion arbor 20 also comprises substantially cylindrical body 30 which is disposed between preferred arbor first end 22 and preferred arbor second end 24. Preferred substantially cylindrical body 30 also defines longitudinal axis 32. While FIG. 1 illustrates the preferred configuration and arrangement of the substantially cylindrical body, it is contemplated within the scope of the invention that the substantially cylindrical body may be configured and arranged in any suitable manner.

Still referring to FIG. 1, preferred expansion arbor 20 also comprises a plurality of slits 40a and 40b. Each of the plurality of preferred slits 40a and 40b includes slit first end 42a and 42b, respectively, and slit second end 44a and 44b, respectively. Preferably, each slit 40a and 40b extends along a portion of substantially cylindrical body 30 between arbor first end 22 and arbor second end 24. Each of the plurality of preferred slits 40a and 40b is substantially parallel to longitudinal axis 32. Preferably, a portion of substantially cylindrical body 30 adjacent to each of the plurality of slits 40a and 40b is adapted to expand radially outward from longitudinal axis 32 when the rotational arbor core is rotated so as to retain a sanding sleeve on the rotational arbor core. While FIG. 1 illustrates the preferred configuration and arrangement of the plurality of slits, it is contemplated within the scope of the invention that the plurality of slits may be configured and arranged in any suitable manner. In addition, it is also contemplated within the scope of the invention that fewer or more than two slits may be provided in the substantially cylindrical body of the preferred expansion arbor.

Still referring to FIG. 1, preferred expansion arbor 20 further comprises a plurality of holes 50a, 50b, 50c, and 50d. Preferably, each of the plurality of holes 50 is disposed at either the slit first end or the slit second end of one of the plurality of slits 40a and 40b. More particularly, preferred expansion arbor 20 comprises hole 50a disposed at slit first end 42a of slit 40a, hole 50b disposed at slit second end 44a of slit 40a, hole 50c is disposed at slit first end 42b of slit 40b, and hole 50d disposed at slit second end 44b of slit 40b. While FIG. 1 illustrates the preferred configuration and arrangement of the plurality of holes, it is contemplated within the scope of the invention that the plurality of holes may be configured and arranged in any suitable manner. In addition, it is also contemplated within the scope of the invention that fewer or more than four holes may be provided in the substantially cylindrical body of the preferred expansion arbor.

Referring now to FIG. 2, a perspective view of a first exemplary rotational arbor core adapted for use with expansion arbor 20 is illustrated. As shown in FIG. 2, the preferred rotational arbor core is designated generally by reference numeral 60. Preferred rotational arbor core 60 is adapted to rotate preferred expansion arbor 20 about longitudinal axis 32 and comprises distal end 62 and proximal end 64. When preferred expansion arbor 20 is placed on rotational arbor core 60, arbor first end 22 is adjacent to distal end 62 of the rotational arbor core and arbor second end 24 is adjacent to proximal end 64 of the rotational arbor core. Preferred rotational arbor core 60 also comprises cap 70 which is adapted to be removably placed into distal end 62. While FIG. 2 illustrates the preferred configuration and arrangement of the rotational arbor core, it is contemplated within the scope of the invention that the arbor core may be of any suitable configuration and arrangement.

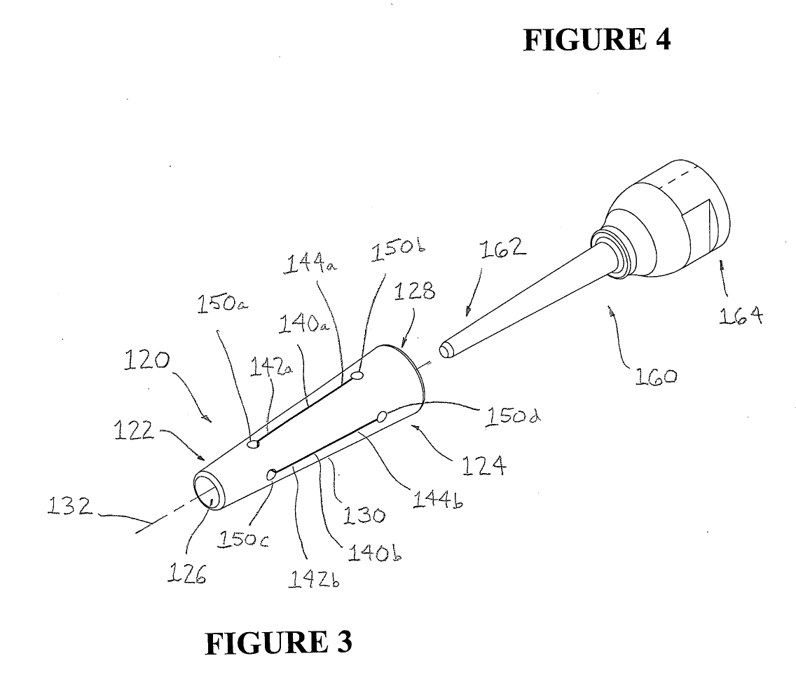

Referring now to FIG. 3, a perspective view of a first alternative embodiment of the expansion arbor in accordance with the present invention is illustrated. As shown in FIG. 3, the preferred expansion arbor is designated generally by reference numeral 120. Preferred expansion arbor 120 comprises arbor first end 122, arbor second end 124, arbor first end opening 126, arbor second end opening 128, substantially cylindrical body 130, longitudinal axis 132, slits 140a and 140b, slit first ends 142a and 142b, slit second ends 144a and 144b, and holes 150a, 150b, 150c, and 150d.

Referring now to FIG. 4, a perspective view of a second exemplary rotational arbor core adapted for use with expansion arbor 120 is illustrated. As shown in FIG. 4, the preferred rotational arbor core is designated generally by reference numeral 160. Preferred rotational arbor core 160 comprises distal end 162 and proximal end 164.

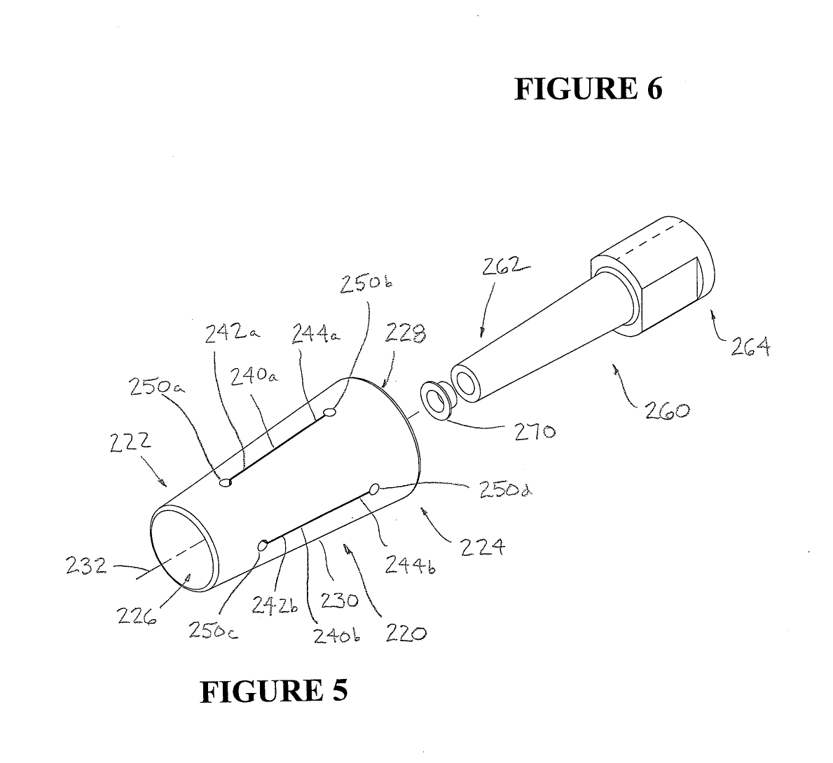

Referring now to FIG. 5, a perspective view of a second alternative embodiment of the expansion arbor in accordance with the present invention is illustrated. As shown in FIG. 5, the preferred expansion arbor is designated generally by reference numeral 220. Preferred expansion arbor 220 comprises arbor first end 222, arbor second end 224, arbor first end opening 226, arbor second end opening 228, substantially cylindrical body 230, longitudinal axis 232, slits 240a and 240b, slit first ends 242a and 242b, slit second ends 244a and 244b, and holes 250a, 250b, 250c, and 250d.

Referring now to FIG. 6, a perspective view of a third exemplary rotational arbor core adapted for use with expansion arbor 220 is illustrated. As shown in FIG. 6, the preferred rotational arbor core is designated generally by reference numeral 260. Preferred rotational arbor core 260 comprises distal end 262 and proximal end 264. Preferred rotational arbor core 260 also comprises cap 270 which is adapted to be removably placed into distal end 262.

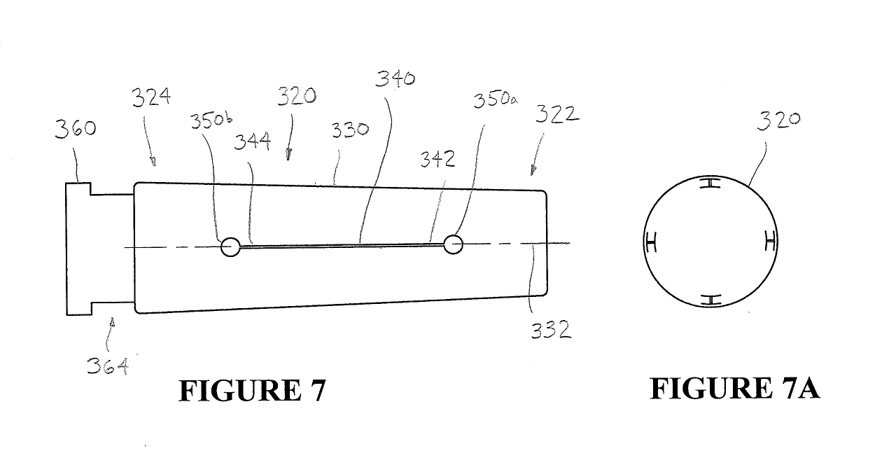

Referring now to FIG. 7, a front view of a third alternative embodiment of the expansion arbor in accordance with the present invention and a fourth exemplary rotational arbor core in a stationary condition is illustrated. As shown in FIG. 7, the preferred expansion arbor is designated generally by reference numeral 320. Preferred expansion arbor 320 comprises arbor first end 322, arbor second end 324, substantially cylindrical body 330, longitudinal axis 332, slit 340, slit first end 342, slit second end 344, and holes 350a and 350b. The preferred rotational arbor core is designated generally by reference numeral 360 and comprises proximal end 364. Preferably, when rotational arbor core 360 is in a stationary condition, substantially the entire the inner surface of expansion arbor 320 is in contact with the outer surface of the rotational arbor core. FIG. 7A is a right end view of expansion arbor 320. As shown in FIG. 7A, preferred expansion arbor 320 comprises four slits and eight holes.

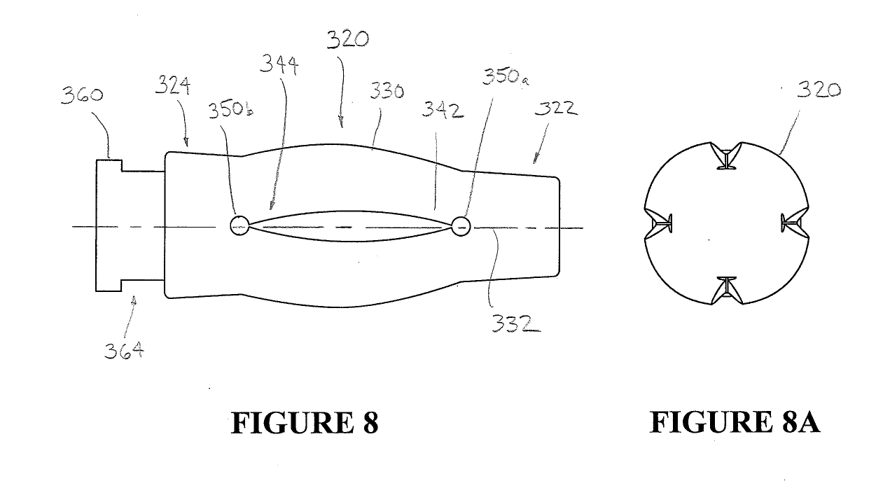

Referring now to FIG. 8, a front view of preferred expansion arbor 320 and exemplary rotational arbor core 360 in an expanded condition is illustrated. As shown in FIG. 8, when preferred rotational arbor core 360 is rotated, preferred expansion arbor 320 expands radially outward from longitudinal axis 332 as it is rotated about the longitudinal axis. More particularly, the portions of preferred expansion arbor 320 adjacent to slit 340 expand radially outward from longitudinal axis 332 so as to retain a sanding sleeve on preferred rotational arbor core 360 as the rotational arbor core and expansion arbor are rotated about the longitudinal axis. FIG. 8A is a right end view of expansion arbor 320 shown in an expanded condition due to the rotational movement of arbor core 360.

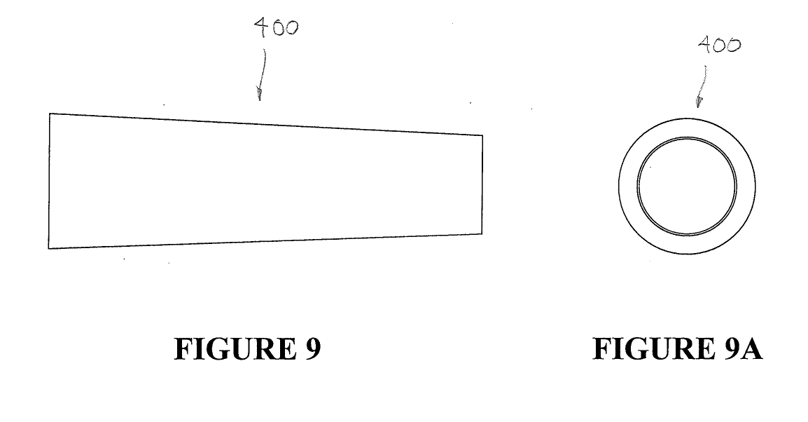

Referring now to FIG. 9, a front view of an exemplary sanding sleeve in accordance with the present invention is illustrated. As shown in FIG. 9, the exemplary sanding sleeve is designated generally by reference numeral 400. Preferably, sanding sleeve 400 is adapted to be retained on a rotational arbor core by an expansion arbor in accordance with the present invention. In addition, the inner surface of exemplary sanding sleeve 400 preferably contacts the outer surface of the preferred expansion arbor when the sanding sleeve is placed onto the expansion arbor and the rotational arbor core. FIG. 9A is a right end view of preferred sanding sleeve 400.

The preferred embodiments of the invention also comprise a method for retaining a sanding sleeve on a rotational arbor core. The preferred method comprises providing an expansion arbor as described hereinabove and illustrated in FIGS. 1-9A. More particularly, the preferred expansion arbor is formed by a silicone that is mixed with a catalyst and poured into a mold. It is also contemplated that a relatively small amount of pigment may be added to the silicone-catalyst mixture in order to provide color. Next, the rotational arbor core is inserted into the mold, and the silicone is allowed to cure and take shape around the arbor core. After the silicone has cured, it is removed from the arbor core and the slits are made.

In addition, the preferred method for retaining a sanding sleeve on a rotational arbor core comprises adhering a portion of the expansion arbor to the rotational arbor core. More particularly, the preferred method comprises washing the rotational arbor core with acetone, heating the arbor core in the area or areas where adhesive will be applied, applying primer to the arbor core in the area or areas where adhesive will be applied, allowing the primer to dry, and applying adhesive to the arbor core. Preferably, a room temperature vulcanizing (RTV) adhesive is applied to the rotational arbor core in the area of the distal end and the proximal end and not in the area of the slits so that the expansion arbor expands radially outward from its longitudinal axis in an area between the first end and the second end. After the preferred RTV adhesive is applied to the rotational arbor core, the expansion arbor is placed onto the arbor core and the adhesive is allowed to cure. After the adhesive cures, the sanding sleeve is placed onto the expansion arbor and rotational arbor core combination. The preferred method for retaining a sanding sleeve on a rotational arbor core further comprises rotating the arbor core and using centripetal force to expand a portion of the expansion arbor radially outward from the longitudinal axis of the expansion arbor so as to retain the sanding sleeve on the rotational arbor core.

In operation, several advantages of the preferred embodiments of the apparatus and method for an expansion arbor are achieved. For example, the preferred embodiments of the invention described and claimed herein are adapted to provide an apparatus and method for an expansion arbor that adequately retains a sanding sleeve on an arbor core. The preferred embodiments of the invention described and claimed herein also provide an apparatus and method for an expansion arbor that has a sufficiently smooth grinding surface adapted to produce straight lines and a high quality finish. The preferred embodiments of the invention described and claimed herein further provide an apparatus and method for an expansion arbor that minimizes or eliminates grinding chatter, particularly on harder grinding surfaces. The preferred embodiments of the invention described and claimed herein still further provide an apparatus and method for an expansion arbor that is safe to use and optimizes production efficiency.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. An expansion arbor adapted for use on a rotational arbor core, said expansion arbor comprising:
(a) an arbor first end, said arbor first end having an arbor first end opening;
(b) an arbor second end, said arbor second end having an arbor second end opening and being spaced apart from the arbor first end;
(c) a substantially cylindrical body, said substantially cylindrical body being disposed between the arbor first end and the arbor second end and defining a longitudinal axis;
(d) a slit, said slit having a slit first end and a slit second end and extending along a portion of the substantially cylindrical body between the arbor first end and the arbor second end;
wherein a portion of the substantially cylindrical body adjacent to the slit is adapted to expand radially outward when the rotational arbor core is rotated so as to retain a sanding sleeve on the rotational arbor core.

2. The expansion arbor of claim 1 wherein the expansion arbor comprises silicone.

3. The expansion arbor of claim 2 wherein the silicone has a hardness in the range of approximately 20 durometers to approximately 30 durometers.

4. The expansion arbor of claim 2 wherein the silicone has a hardness of approximately 25 durometers.

5. The expansion arbor of claim 2 wherein the silicone comprises a combination of different silicones.

6. The expansion arbor of claim 1 wherein the arbor first end is adjacent to a distal end of the rotational arbor core.

7. The expansion arbor of claim 1 wherein the arbor first end opening is smaller than the arbor second end opening.

8. The expansion arbor of claim 1 wherein the arbor second end is adjacent to a proximal end of the rotational arbor core.

9. The expansion arbor of claim 1 wherein the slit is substantially parallel to the longitudinal axis.

10. The expansion arbor of claim 1 wherein the substantially cylindrical body comprises a plurality of slits.

11. The expansion arbor of claim 1 wherein the substantially cylindrical body comprises a hole, said hole being disposed at either the slit first end or the slit second end.

12. The expansion arbor of claim 1 wherein the substantially cylindrical body comprises a first hole disposed at the slit first end and a second hole disposed at the slit second end.

13. The expansion arbor of claim 1 wherein the substantially cylindrical body comprises a plurality of slits and a plurality of holes.

14. The expansion arbor of claim 1 wherein the substantially cylindrical body comprises a plurality of slits, each of said slits having a slit first end and a slit second end, and a plurality of holes, each of which is disposed at either one of the slit first end or one of the slit second ends.

15. The expansion arbor of claim 1 wherein an adhesive adheres the expansion arbor to the rotational arbor core.

16. An expansion arbor adapted for use on a rotational arbor core, said expansion arbor comprising:
(a) an arbor first end, said arbor first end having an arbor first end opening;
(b) an arbor second end, said arbor second end having an arbor second end opening which is larger than the arbor first end, and said arbor second end being spaced apart from the arbor first end;
(c) a substantially cylindrical body, said substantially cylindrical body being disposed between the arbor first end and the arbor second end and defining a longitudinal axis;
(d) a plurality of slits, each of said plurality of slits having a slit first end and a slit second end and each of said plurality of slits extending along a portion of the substantially cylindrical body between the arbor first end and the arbor second end and substantially parallel to the longitudinal axis;
(e) a plurality of holes, each of said plurality of holes being disposed at either one of the slit first ends or one of the slit second ends;
wherein the expansion arbor comprises silicone and a portion of the substantially cylindrical body adjacent to each of the plurality of slits is adapted to expand radially outward when the rotational arbor core is rotated so as to retain a sanding sleeve on the rotational arbor core.

17. A method for retaining a sanding sleeve on a rotational arbor core, said method comprising:
(a) providing an expansion arbor, said expansion arbor comprising:
(i) an arbor first end, said arbor first end having an arbor first end opening;
(ii) an arbor second end, said arbor second end having an arbor second end opening and being spaced apart from the arbor first end;
(iii) a substantially cylindrical body, said substantially cylindrical body being disposed between the arbor first end and the arbor second end and defining a longitudinal axis;
(iv) a slit, said slit having a slit first end and a slit second end and extending along a portion of the substantially cylindrical body between the arbor first end and the arbor second end;
wherein a portion of the substantially cylindrical body adjacent to the slit is adapted to expand radially outward when the rotational arbor core is rotated so as to retain a sanding sleeve on the rotational arbor core;
(b) placing the expansion arbor on the rotational arbor core;
(c) placing the sanding sleeve on the expansion arbor; and
(d) rotating the rotational arbor core.

18. The method of claim 17 further comprising adhering a portion of the expansion arbor to the rotational arbor core.

19. The method of claim 17 further comprising expanding a portion of the expansion arbor radially outward so as to retain the sanding sleeve on the rotational arbor core.

20. The method of claim 17 further comprising using centripetal force to expand a portion of the expansion arbor radially outward so as to retain the sanding sleeve on the rotational arbor core.
